(19) United States
(12) Patent Application Publication
(10) Pub. No.: US 2018/0215967 A1
(43) Pub. Date: Aug. 2, 2018

(54) HIGH STRENGTH PANEL ADHESIVE

(71) Applicant: Zephyros, Inc., Romeo, MI (US)

(72) Inventor: Jason Walker, Lenox, MI (US)

(73) Assignee: Zephyros, Inc., Romeo, MI (US)

(21) Appl. No.: 15/578,391

(22) PCT Filed: Jun. 2, 2016
(86) PCT No.: PCT/US16/35494

§ 371 Date: Nov. 30, 2017

Related U.S. Application Data
(60) Provisional application No. 62/169,647, filed on Jun. 2, 2015.

(51) Int. Cl. C09J 163/00; B05D 5/10; B05D 3/02; B05D 3/12

(52) U.S. Cl. CPC C09J 163/00; B05D 5/10; C08K 7/20; B05D 3/12; B05D 3/0254

(57) ABSTRACT

The present teachings relate generally to a one-part epoxy-based adhesive paste composition, comprising: at least about 20% by weight of a liquid epoxy resin component; an amount of a halogen-free flame retardant sufficient so that the resulting cured adhesive composition exhibits sufficient flame retardancy for a vertical burn length of less than 6 inches according to FAR 25,853; at least two curing agents; and a lightweight low-density filler.

### FIELD

The present teachings relate to a one-part pumpable epoxy-based adhesive paste having improved fire retardancy characteristics and multiple curing agents to allow for low initial cure temperatures.

### BACKGROUND

There is an ongoing need in many industries (e.g., transportation, such as in marine craft, rail cars, automotive vehicles, aircraft, or otherwise; building construction) for improved compositions that exhibit flame retardancy, ease of use, relatively good performance for their intended purposes, and/or reduction in the number of steps needed for processing the compositions for their intended use. Examples of such applications include adhesive or other compositions for use in potting, edge close-out, local reinforcement and/or core splices of one or more bodies, such as a body having hollow sections, cavities, and/or void-containing structures. One such body is a honeycomb structure panel of a type commonly employed in aerospace applications.

Though two-component formulations often provide good performance, they tend to suffer from a relatively short working life, i.e., as measured per ASTM D1338-99 (2011). As a result, the amount of time that is available upon subjecting components of a formulation to curing conditions is relatively short and limits the ability to appropriately shape and locate it in the desired location. That is, because many two-component formulations are curable at room temperature, from the time the components are mixed, there will be a build-up of curing, which will increase the viscosity and attendant rigidity of the resulting material. The build-up of viscosity and attendant rigidity hinders hand application or application via a nozzle (such as by a pump or gun).

Examples of commercially available materials finding similar application include L-9001 and L-9003 (both being one component heat curable epoxy based compositions), available from L&L Products, Inc. (Romeo, Mich., USA).

While many existing compositions meet some of the above needs, there continues to be a need for improved materials that simplify manufacture and/or use of the compositions, which help reduce the amount of such compositions that are needed, or that meet some other need. There is especially a need for additional materials that offer an appropriate balance of viscosity (e.g., to allow for filling of cavities, or other voids, or to otherwise permit ready ability for handling during its working life), and good resulting strength and/or modulus characteristics (e.g., in compression) upon cure.

### SUMMARY

The present teachings relate generally to a one-part heat curable composition. The composition may be a one-part adhesive paste composition. For example, the composition may be a one-part epoxy-based adhesive paste composition. The composition may include a liquid epoxy resin component.

The teachings herein provide for a one-part epoxy-based adhesive paste composition, comprising: at least about 20% by weight of a liquid epoxy resin component; and an amount of a halogen-free flame retardant sufficient so that the resulting cured adhesive composition exhibits sufficient flame retardancy for a vertical burn length of less than 2 inches according to FAR 25.853; at least two curing agents; and a lightweight low-density filler.

The paste may preferably be pumpable. The composition (e.g., paste) may include exactly two curing agents. The composition may include more than two curing agents. The liquid epoxy resin may be a bisphenol A diglycidylether. The liquid epoxy resin may have a maximum epoxy equivalent weight of at least about 250 grams/equivalent per ASTM D-1652-11e1. The composition may include a liquid epoxy in an amount of from about 20% to about 80% by weight, from about 30% to about 70% by weight, or even from about 40% to about 80% by weight. The liquid epoxy resin may be selected to solubilize the liquid epoxy resin with one or more of the curing agents. The liquid epoxy resin may be selected to solubilize the liquid epoxy resin with exactly one of the curing agents. The composition may include a diluent. The lightweight low density filler may include an acrylonitrile copolymer shell. The lightweight low density filler may reduce the density of the epoxy-based paste while increasing the volume of the epoxy-based paste. At least one of the curing agents may be a modified aliphatic amine. The filler may include glass microspheres. The filler may consist essentially of hollow glass microspheres characterized by a particle size of from about 20 microns to about 70 microns, whereby at least 50% of the particles have a particle size of at least 35 microns. The composition may include an aliphatic amine curing agent and/or a semi-micronized dicyandiamide curing agent. The composition may include a curing agent to lower the cure temperature of the composition. The composition may include a plurality of curing agents so that charring of the composition is substantially prevented. The proportion of the weight of the epoxies, relative to the filler may be about 5:1 to about 1:2. Upon achieving a degree of cure of at least about 75%, a resulting cured adhesive composition exhibits sufficient flame retardancy to meet the requirements of one or more of FAR 25.853. The liquid epoxy resin may decrease the viscosity of the adhesive paste so that it is able to be more easily pumped directly into one or more honeycomb openings.

The present teachings further provide for a method of reinforcing and adhering a honeycomb structure comprising: providing a one-part epoxy-based paste; providing a honeycomb panel having a plurality of openings; pumping or troweling the epoxy-based paste into one or more of the plurality of openings; compressing the epoxy-based paste within the one or more openings that receive the paste; and curing the epoxy-based paste.

### DETAILED DESCRIPTION

The explanations and illustrations presented herein are intended to acquaint others skilled in the art with the invention, its principles, and its practical application. The specific embodiments of the present invention as set forth are not intended as being exhaustive or limiting of the invention. The scope of the invention should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

This application claims the benefit of the tiling date of U.S. Provisional Application No. 62/169,647, filed Jun. 2, 2015, the entirety of the contents of this application being hereby incorporated by reference for all purposes.

The present teachings relate generally to a one part heat curable composition. The composition may be a one-part epoxy-based adhesive paste composition. The composition may include an epoxy resin component. The composition may include a filler having a relatively high surface area to weight ratio; that is, taking into account the density of the filler and its particle sizes. The composition may also include an amount of a flame retardant (e.g., a halogen-free flame retardant, such as a phosphorus containing flame retardant) sufficient so that when the adhesive paste composition is cured it will meet the requirements for flame retardancy as set forth in 14 C.F.R. § 25.853 (the United States Code of Federal Regulations for aerospace compartment interiors, including but not limited to 14 C.F.R. § 25.853(a), and the referenced Appendix F and procedures referenced therein (e.g., 60 second vertical burn test per 14 C.F.R. § 25.853 App. F Part 1(a)(i), smoke density test per 14 C.F.R. § 25.853 App. F Part V (b)), all of which are incorporated by reference for all purposes). An amount of a curing agent may be included in the composition. Multiple curing agents are preferably included in the composition. The epoxy resin, the filler, any flame retardant and the curing agent are admixed to define a substantially homogenous admixture, thereby defining a mass of adhesive paste. Curing may be over a period of less than 2 hours, less than 1 hour, or even less than 40 minutes. Additionally, it is possible to avoid the need for a two-part admixture and the potential inconveniences associated therewith.

As used herein, substantially entirely cured refers to a state of curing when, with the passage of time, a material herein exhibits substantially no variation in its mechanical properties. The paste compositions described herein may be cured upon contact with a heat source and may be considered substantially entirely cured when the composition has a Shore D hardness of at least about 20, as measured by ASTM D-2240-05.

Turning now to a more complete description of the ingredients of the composition. The epoxy resin component may include a liquid epoxy resin component. The epoxy component may be combined with one of the curing agents to solubilize the curing agent. The epoxy resin may be such that the composition of the present teachings exhibits, when cured, one or any combination of a relatively high compressive strength, a relatively high compression modulus, a relatively high tube shear strength, all while exhibiting acceptable flame retardancy and a relatively low density.

The liquid epoxy resin may be a bisphenol A diglycidylether. The liquid epoxy resin may have an epoxy equivalent weight per ASTM D-1652-11e1 of about 185 to about 205 grams/equivalent (g/eq). The liquid epoxy resin may have a viscosity (at 25° C., per ASTM D-44514e2) in the range of about 1000 to about 10,000 centipoise mPa·s, e.g., about 4,000 to about 7,000 mPa·s. An example of a commercially available liquid epoxy resin is DER 362, available from The Dow Chemical Company, Midland, Mich.

The epoxy resin diluent, if present, may be an aromatic monofunctional epoxy. The epoxy resin diluent may be a nonyl phenol glycidyl ether. The epoxy resin diluent may have a viscosity at 25° C. (cps) per ASTM D-445-14e2 of about 80 to about 180, e.g., about 100 to 140. The epoxy resin diluent may have an epoxy equivalent weight (g/eq) per ASTM D-1652-11e1 of about 200 to about 400, e.g., about 300 to about 325. The epoxy resin diluent may be commercially available, such as Erisys GE-12, available from CVC Thermoset Specialties. Alternatively, the composition may be substantially free of any diluent.

The filler may be a relatively high volume to weight filler. The filler may have a density (i.e., a true particle density), per ASTM C128-12 of about 0.01 to about 5 grams/milliliter (g/ml), about 0.20 to about 1 g/ml, or even about 0.30 to 0.40. The filler may be an organic filler, an inorganic filler, or a combination of both. The filler may be a hollow filler. The filler may include hollow particles which may be glass microspheres. The filler may consist essentially of glass microspheres. The filler may have an elongated geometry. The filer may have a spherical geometry. The filler may be in a particulated form. The filler may be in the form of a rod, a bead, a whisker, a platelet or any combination thereof. The filer may include silicon. The filler may include amorphous silica. The filler may include soda lime borosilicate glass. The filler may include fumed silica. One illustrative filler includes a plurality of glass beads. For example, the glass beads may be glass microspheres. The glass beads may be hollow glass microspheres. An example of a commercially available filler is a glass bubble product offered by Potters Industries under the designation 34P30. The filer may be present, by weight, in a proportion of filler relative to the total epoxy resin component of about 1:5 to about 2:1, e.g., about 1:3 to about 1:1, or even about 1:2.5. The proportion of the weight of the epoxies, relative to the filler is about 5:1 to about 1:2. The filler may include or may consist essentially of hollow glass microspheres characterized by a particle size of from about 20 microns to about 70 microns, whereby at least 50% of the particles have a particle size of at least 35 microns.

The halogen-free flame retardant may include a compound in which phosphorus is present. The flame retardant may include a polyphosphate. For example, it may include an ammonium polyphosphate. An example of a commercially available flame retardant useful herein is JLS-PNP1C or JLS APP, available from JLS.

The teachings herein may employ an amount of a flame retardant (e.g., a halogen-free flame retardant) sufficient so that when the adhesive paste composition is fully cured, the resulting cured adhesive composition exhibits sufficient flame retardancy to meet the requirements of one or more of the 60 second vertical burn test per 14 C.F.R. § 25.853 App. F Part 1(a)(i), the smoke density test per 14 C.F.R. § 25.853 App. F Part V (b)), or the smoke toxicity test per AITM 3.0005 (as required by Airbus).

By way of example, the flame retardant may be present in an amount of about 10 to about 40, e.g., about 15 to about 30, or even about 20 to about 25 percent by weight of the overall weight of the composition of the teachings. The proportionate amount, by weight, of the flame retardant relative to the epoxy resin may be about 2:1 to about 1:3, e.g., about 1:2.

The one or more curing agents may include a suitable epoxy curing agent. They may include a curing agent accelerator. The one or more curing agents may have one or more amine functionalities. The curing agent may include or consist of a polyamide. The curing agent may include or consist of an aliphatic amine, e.g., it may include or consist of a polyfunctional aliphatic amine. The curing agent may be a cycloaliphatic amine. The curing agent may include one or more imidazole functional groups. The curing agent may have an amine value of about 20 to 100, e.g., about 50 to about 65. Examples of commercially available curing agents include, without limitation, Ancamide 2442, available commercially from Air Products, Omicure DDA-50, available commercially from CVC Thermoset Specialties and Curezol 2MZ-Azine available from Air Products.

An amount of a curing agent sufficient to cause curing of the adhesive paste composition to a fully cured state, when the adhesive paste composition is subjected to a curing condition (e.g., an elevated temperature) over a period not to exceed about 2 hours, while retaining a working life of at least 1 hour, at least 2 hours at least 4 hours or even at least 6 hours at room temperature. By way of illustration, the curing agent may be present in a proportionate amount, by weight, to the total amount of epoxy resin of about 1:1 to about 1:10, e.g., about 1:5.

For achieving the cure rates as taught herein, it is possible that the dimensions of a mass of the adhesive composition of the teachings herein may have a thickness that is below about 100 mm, below about 50 mm, below about 30 mm, below about 20 mm, or even below about 10 mm (e.g., thickness may be about 1 mm, about 2 mm, about 3 mm, about 4 mm, about 5 mm, about 6 mm, about 7 mm, about 8 mm, about 9 mm or about 10 mm). Width and/or length may be in the range of about 3 meters, about 2 meters, about 1 meter, about 0.5 meter, about 0.3 meter, or smaller.

Other additives may be included in the composition of the present teachings, including one or more of a UV stabilizer, an antioxidant, a processing aid, a blowing agent, a plasticizer, a curing accelerator, colorant, impact modifier, a flexibilizer, a thickener, or a reinforcement (e.g., a fibrous reinforcement). The compositions of the teachings may be provided with a release layer, a handling film, or both.

Mixing is performed under conditions that impart relatively low shear forces to the admixed ingredients, to thereby help to avoid heat generation that would induce premature curing. It is possible that a planetary mixer may be employed for any of the mixing steps. Mixing proceeds until all ingredients appear to be substantially homogeneously mixed. Mixing may proceed in a plurality of relatively brief intervals (e.g., about 5 to about 30 seconds, such as about 10 to about 15 seconds), or at some other interval sufficient to help avoid heating.

The mass of adhesive paste may be in pumpable form. The composition may be applied within the interstices of a honeycomb form (e.g., a non-metallic honeycomb form, such as a core of a sandwich laminate). The composition may be applied along one or more side edges of a panel structure, which may be a honeycomb form.

The compositions may be maintained in a refrigerated (e.g., frozen) condition until the time of their intended use. For example, the teachings herein envision maintaining the compositions herein at a temperature of less than about 10′C, 5° C., 0° C., −10′C, or even −20° C. At the time of the intended use, the teachings envision allowing the compositions herein to be exposed to an activation condition (e.g., heat, moisture, radiation, or otherwise). For example, the teachings may employ a step of allowing the compositions to warm to a predetermined temperature (e.g., about 23° C. or higher) for a sufficient amount of time so that substantially homogeneous curing of the composition occurs substantially throughout the composition.

The teachings herein find application in the transportation industry (e.g., for use in automotive vehicles, aircraft, railcars, or otherwise, such as in panel structures), in the construction industry (e.g., as wall panels), or elsewhere.

Articles made using the compositions of the teachings herein are also envisioned within the scope of the teachings. Examples of such articles include, without limitation, potted structures, panels with an edge close-out, locally reinforced structures (such as a locally reinforced panel), a core-spliced body (e.g., a spliced honeycomb structural panel). The articles may be panels (e.g., ceiling and/or side walls), partitions, cargo and/or baggage compartments, or the like. Any of the foregoing may include a honeycomb structure that defines a plurality of voids into which the composition of the present teaching is inserted.

The compositions of the present teachings desirably may exhibit one or any combination of the following characteristics. The composition of the present teachings may exhibit an uncured density per ASTM D729 of about 0.1 to about 1.5 g/mL, e.g., about 0.5 g/mL The composition of the present teachings may exhibit a compressive strength at 23° C. per ASTM D695-10, in its cured state, of about 2000 psi to about 5000 psi, e.g., at least about 2800 psi or even at least about 3000 psi.

The compositions of the present teachings, in a cured state also pass one or any combination of the 60 second Vertical Burn test per 14 C.F.R. § 25.853 App. F Part 1(a)(i); Smoke Density per 14 C.F.R. § 25.853 App. F Part V (b), or Smoke Toxicity per AITM 3.0005.

The adhesive paste compositions of the present teachings exhibit storage stability under refrigerated conditions (e.g., at a temperature in the range of about −15 to about 15° C.) in a sealed container (e.g., sealed from one or more of light, oxygen, moisture, heat) for a period of at least about one month, 3 months, 6 months or at least about 1 year (e.g., a storage stability of about 1 month to about 2 years). During such period of storage stability the time of the working life, the time to cure to a fully cured state, or both, of the adhesive paste compositions will be within 25% of the working life and/or time to cure to a fully cured state, at the time the composition is prepared.

The ingredients of the following Table 1 are admixed using low shear mixing to avoid producing too much heat. As applicable generally to the teachings herein, the liquid epoxy resin and a first curing agent must be fully mixed with the liquid epoxy resin so that it solubilizes. If other solid ingredients are added simultaneously with the first curing agent, it is possible that the first curing agent will not completely dissolve. As a result, a portion of the liquid epoxy resin could leach out of the composition during cure. It is thus preferred that the first curing agent is fully dissolved (e.g., solubilized) during mixing.

TABLE 1

| Ingredient | Parts by Weight |
|---|---|
| Liquid Epoxy Resin | 47.45 |
| Flame Retardant | 11.33 |
| Filler/Glass | 17.30 |
| Curing Agent/Amine | 8.67 |
| Curing Agent/Cyanoguanidine | 1.10 |
| Filler/Calcium Carbonate-Silica | 1.60 |
| Cyanurotriamide | 12.55 |
| Total | 100.00 |

The composition of Table 1 is expected to provide performance results approximating those (e.g., within about 20%, or even about 10% of the recited values) of the following Table 2.

The batch of the composition of Table 1 is sealed in a fluid tight bag and stored at a temperature of about −6° C. until testing. At time of testing the composition is allowed to come to room temperature, and is cured at about 265° F. for about 20 minutes. Samples for testing are made from material that has been stored for a period of one day from mixing, one week from mixing, one month from mixing, three months from mixing, and one year from mixing, the material being stored in a sealed fluid tight bag and refrigerated as previously described.

The composition of Table 1 is expected to provide performance results approximating those (e.g., within about 20%, or even about 10% of the recited values) of the following Table 2.

TABLE 2

| Property | Sample Value | |
|---|---|---|
| Density per ASTM D729 | 0.59 | g/mL |
| Compression Stress at 23° C. per ASTM D695 | 3000 | psi |
| Compressive Modulus at 23° C. per ASTM | 266244 | psi |
| D695-10 | | |
| Vertical Burn Length per 14 C.F.R. §25.853 | 1.9 | inches |
| part a | | |

It is possible that a single epoxy resin, a single flame retardant, and/or a single filler may be employed. It is also, possible that two or more flame retardants may be employed, that two or more fillers may be employed, that two or more curing agents may be employed. In the event that two or more flame retardants, fillers, and or curing agents are employed, it is possible that the total amount of any such additional (beyond a single one) flame retardant, filler, and/or curing agent may be present in an amount by weight that it less than about 20 percent, or even about 10 percent of the total of the respective flame retardant, filler, or curing agent. Thus, for example, a flame retardant may include a 9:1, 4:1 or even a 1:1 admixture of two flame retardants; a filler may include a 4:1 or even 10:1 admixture of two fillers; or the curing agent may include a 4:1 or 8:1 admixture of two curing agents. As an example, the total amount of flame retardant may present in an amount of about 20% to about 30% by weight, while a single flame retardant may be present in an amount of about 8% to about 13% by weight. The total amount of curing agent may present in an amount of about 5% to about 15% by weight, while a single curing agent may be present in an amount of about 0.5% to about 3% by weight. The total amount of filler may present in an amount of about 10% to about 30% by weight, while a single filler may be present in an amount of about 0.5% to about 3% by weight.

As seen from the above, compositions of the teachings enable excellent working life. For example, it is possible that a working life for a mass of the composition of the teachings will be at least about 2 hours, 3, hours, 4 hours or longer at room temperature.

It is possible that upon conclusion of the working life, the mass of the composition of the teachings will cure to substantially fully cured state over a period of less than about 2 hours, less than about 1 hour, or even less than about 40 minutes. The composition may cure upon exposure to a stimulus, which may be a heat source (e.g., heat provided by an oven, by induction heating or the like). The composition may cure upon exposure to elevated temperature in the range of from about 225° F. to about 300° F., or even from about 250° F. to about 280° F.

Masses of the compositions of the teachings, prior to curing, may exhibit excellent shelf life and storage stability. For example, when stored at a temperature below about 0° C. (e.g., about −5° C. to about 0° C.) for a period of at least about 3 months, 6 months, 9 months, or even 12 months, the working life will remain substantially unchanged (e.g., with about 15% of the working life of the uncured composition as initially prepared) relative to the working life of the uncured composition as initially prepared. The mass of adhesive paste preferably exhibits a shelf-life period of at least about 3 months, during which shelf-life period the mass of adhesive paste exhibits a degree of cure of below about 5%.

Both during and after curing, the compositions of the present teachings may exhibit no shrinkage.

The following comments pertain generally to all teachings. Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the invention of a range in terms of at “‘x’ parts by weight of the resulting composition” also contemplates a teaching of ranges of same recited amount of xY in percent by weight of the resulting composition.

Unless otherwise stated, any test method standard referenced herein is for the version existing as of the earliest filing date in which the standard is recited.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of, or even consist of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps. Moreover, unless expressly set forth, the recitation of “first”, “second”, or the like does not preclude additional ingredients, steps, or other elements. All references herein to elements or metals belonging to a certain Group refer to the Periodic Table of the Elements published and copyrighted by CRC Press, Inc., 1989. Any reference to the Group or Groups shall be to the Group or Groups as reflected in this Periodic Table of the Elements using the IUPAC system for numbering groups. It is understood that the above description is intended to be illustrative and not restrictive.

Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1: A one-part epoxy-based adhesive paste composition, comprising:
a. at least about 20% by weight of a liquid epoxy resin component;
b. an amount of a halogen-free flame retardant sufficient so that the resulting cured adhesive composition exhibits sufficient flame retardancy for a vertical burn length of less than 6 inches according to FAR 25.853;
c. a first curing agent and a second curing agent, wherein the first curing agent is a modified aliphatic amine that is soluble in the liquid epoxy resin; and
d. a first filler including a lightweight low-density filler.

2: The composition of claim 1, wherein the paste is pumpable.

3: The composition of claim 2, wherein the liquid epoxy resin is a bisphenol A diglycidylether.

4: The composition of claim 3, wherein the liquid epoxy resin has a maximum epoxy equivalent weight of at least about 205 grams/equivalent per ASTM D-1652-11e1.

5: The composition of claim 3, wherein the liquid epoxy resin has a maximum epoxy equivalent weight of at least about 250 grams/equivalent per ASTM D-1652-11e1.

6: The composition of claim 1, wherein the first curing agent is selected so that it solubilizes in the liquid epoxy resin in the absence of any additional diluent.

7: The composition of claim 1, wherein the lightweight low density filler includes an acrylonitrile copolymer shell.

8: The composition of claim 7, wherein the lightweight low density filler reduces the density of the epoxy-based paste.

9. (canceled)

10: The composition of claim 1 including a second filler comprising glass microspheres.

11: The composition of claim 10, wherein the second filler consists essentially of hollow glass microspheres characterized by a particle size of from about 20 microns to about 68 microns, whereby at least 50% of the particles have a particle size of at least 38 microns.

12: The composition of claim 1, wherein the second curing agent is a semi-micronized dicyandiamide curing agent.

13: The composition of claim 12, wherein at least one of the first and second curing agents is selected to lower the cure temperature of the composition.

14: The composition of claim 1, wherein the proportion of the weight of the epoxies, relative to the fillers is from about 5:1 to about 1:2.

15. (canceled)

16: The composition of claim 1, wherein the epoxy resin decreases the viscosity of the adhesive paste so that it is able to be pumped directly into one or more honeycomb openings.

17: The composition of claim 1, wherein upon cure, the composition exhibits a compression stress value per ASTM D695 of at least about 2000 psi, or even at least about 2500 psi.

18. (canceled)

19: The composition of claim 1, wherein upon cure, the composition exhibits a compressive modulus value per ASTM D695-10 of at least about 60,000 psi or even more than about 120,000 psi.

20. (canceled)

21: A method of reinforcing and adhering a honeycomb structure comprising:
a) providing a one-part epoxy-based paste;
b) providing a honeycomb panel having a plurality of openings;
c) pumping or troweling the epoxy-based paste into one or more of the plurality of openings;
d) compressing the epoxy-based paste within the one or more openings that receive the paste;
e) curing the epoxy-based paste.

22: The method of claim 21, wherein the curing includes exposing the paste to an elevated temperature of at least about 225° F.

23: The method of claim 21, wherein the curing occurs in less than 2 hours, less than 1 hour, or even less than 40 minutes.

24-25. (canceled)

26: The method of claim 21, wherein the epoxy based paste includes a second curing agent.
